(19) United States
(12) Patent Application Publication
(10) Pub. No.: US 2009/0085253 A1
(43) Pub. Date: Apr. 2, 2009

(54) Construction Product

(76) Inventor: Leon Kruss, Waverley (AU)

Correspondence Address: OLIFF & BERRIDGE, PLC, P.O. BOX 320850, ALEXANDRIA, VA, 22320-4850, US

(21) Appl. No.: 12/223,658

(22) PCT Filed: Mar. 20, 2007
(86) PCT No.: PCT/AU2007/000335

§ 371 Date: Aug. 6, 2008

(30) Foreign Application Priority Data
Mar. 22, 2006 (AU) 2006901478
Nov. 2, 2006 (AU) 2006906072
Nov. 14, 2006 (AU) 2006906350
Feb. 15, 2007 (AU) 2007900759

(51) Int. Cl. C04B 24/26; C04B 18/26; B28B 1/14; B28B 3/20

(52) U.S. Cl. 264/333; 524/5; 264/299

(57) ABSTRACT

The invention relates to a construction element which has advantages over regular concrete elements by being much lighter, stronger and less expensive. The element comprises at least 15% by weight of cement, particulate filler material, ethylene-vinylacetate copolymer binder and optionally cellulose ether and PYA binder. The filler material may be selected from particulate wood, particulate elastomeric material, fiyash, crushed rock, cellulosic materials or sand. The invention also relates to a slurry mixture for producing the construction element. The said element may have a variety of shapes, such as sheets, bricks, beams, blocks, panels and boards.

### TECHNICAL FIELD

The present invention relates to construction products, particularly a construction element, as well as a method of producing the construction element. The products may have a variety of shapes, such as sheets, bricks, beams, blocks or the like, and especially may be panels and boards. They are lightweight and strong, and can have a variety of uses in the construction industry.

### BACKGROUND ART

Cement and concrete products are commonly used in the construction industry. Such products have some disadvantages, especially because of their weight, and lack of strength, particularly in thin sheet form. But they also have many advantages, as evidenced by their wide use in the industry, and they are fire proof and have good acoustic properties. They can be cast or created in a wide variety of shapes and sizes, such as panels, boards, bricks, blocks, sheets, beams and slabs. A product would be very useful, that can take the place of cement and concrete products, and which can have good fire resistance, good acoustic properties, and which is lightweight, strong and durable.

One product that has many of these advantages is described in International patent application no. WO2000/002626 (PCT/AU99/00555), by the present inventor. That describes a light weight cement containing product that contains a major portion of sawdust type material, cement, and a minor portion of a cellulose ether compound, and optionally some other components such as polystyrene beads, coated fly ash, a cement setting agent, and sand.

Another product that has many of these advantages is described in International patent application no. WO2002/066395 (PCT/AU02/00189), by the present inventor. That document describes a building material which contains a major portion of cement, fillers such as coated fly ash or elastomeric beads, and minor portions of a polyvinyl alcohol type bonding agent, as well as optionally other components such as sand, aggregates, fibre reinforcement, or colouring agents.

Another product is described in WO2000/28809 (PCT/US99/27267) by Joseph Luongo, which describes a wallboard, preferably composed of calcined gypsum and perlite and with a polymer bonding agent. An example is provided of a wallboard made from perlite alone, with vinyl acetate as the polymer bonding agent, and with a small proportion of cement present, which constitutes up to 15% by weight compared to the total weight of slurry.

### DISCLOSURE OF THE INVENTION

These and other advantages and requirements are met with the present invention, which in one broadest form are summarised at the end of this description.

### MODES FOR CARRYING OUT THE INVENTION

The invention concerns a construction element which can take the place of elements made of concrete, but which may have advantages over regular concrete elements, by being much lighter, and stronger, less expensive, or having other advantages apparent to people engaged in the construction industry, or which may is provide a useful alternative to elements made from conventional types of concrete.

The invention also relates to the slurry mixture, which is prepared in order to produce this construction element, and to a method for producing the construction element, especially by casting or extrusion.

The construction element is composed of at least 15% and preferably at least 25% by weight of cement (relative to the total weight of the initial mixture which contains added water), particulate filler material, a ethylene and vinyl acetate copolymer binder, and optionally other components such as a cellulose ether, or a PVA binder, especially a cross-linked PVA binder, and the residual water that remains after all the components are mixed together in the presence of water, and then allowed to set, dry out and harden. The construction element may be formed into any of a variety of shapes that are useful in the construction industry, by any suitable process, but especially by casting or extrusion.

Preferably, the ethylene and vinyl acetate copolymer binder used in the invention is a dry powder before mixing. Any ethylene and vinyl acetate copolymer binder may be used in the present invention.

One of the preferred ethylene and vinyl acetate copolymer binder is an “Elotex” redispersible polymer binder, such as that available from the “National Starch and Chemical Company”, or its division of the “Elotex AG” company of Sempach Station in Switzerland. In particular, the most preferred ethylene and vinyl acetate copolymer binder, is the “Elotex FX2350” product, from Elotex AG, which is a redispersible polymer binder. This product is a free-flowing white powder.

Another vinyl acetate/ethylene copolymer that may be used is “DA-1100” type available from Dairen Chemical Corporation (Taipei Taiwan), which is a water-dispersible vinyl acetate/ethylene copolymer powder that is readily dispersible in water to form a stable emulsion. This EVA is particularly fast drying.

The concrete panels and boards produced in accordance with the invention may be lightweight, and may have densities preferably in the order of from 400 to 600 kg/m³, or in some circumstances up to 800 kg/m³. Most preferably a density of from 400 to 500 kg/m³ is ideal. The lightweight panels made in accordance with the invention may have a weight of from 20 to 50 kg/m² and most preferably around 30 kg/m². These panels are superlight, which is a description that refers to concrete type panels that are between 400 to 1,000 kg per cubic metre. Normal concrete is around 2,400 kg/m³.

They also may have high strength, such as having a tensile strength in the range of 6 to 20 MPa. The panels and boards may be fire resistant of from 2 to 4 hours. The building elements also have good sound resistance qualities, with a rating of from 46 to 58 dB, for example. In addition, the building elements may be versatile and easily workable and can be created with a variety of high quality surface finishes.

The boards and panels may be moulded, or most preferably, cast or extruded, for example. Extruded or cast panels may additionally contain internal air voids, to decrease their overall weight further, if desired. The lightweight and strong panels according to the invention can be a cost effective and versatile building product that can be substituted for traditional bricks, precast concrete and plasterboard.

### EVA Copolymer Component

The ethylene and vinyl acetate copolymer (also known as “EVA”) binder component is ideally added in the form of a dry powder to the other dry ingredients. While any suitable ethylene and vinyl acetate copolymer binder may be utilised in the invention, it has been found that an “Elotex” or the “DA-1100” Dairen Chemical Co, sourced EVA copolymers gives surprisingly effective results.

In any ethylene and vinyl acetate copolymer binder, it is primarily composed of a polymer base of ethylene and vinyl acetate. It may contain a small amount of protective colloid of polyvinylalcohol, as a stabilize. It may contain as a small amount of additive, some mineral anti-block agents. It normally may not contain any significant amounts of any plasticizers, solvents, or film-forming agents.

It is also preferred that the ethylene and vinyl acetate copolymer binder is a redispersible powder polymer. Such redispersible polymers are generally thermoplastic polymers that are produced by spray drying an emulsion based on monomers of ethylene and vinyl acetate. Generally, latex particles are combined with a protective colloid, and the polymer particles in water, and spray dried with an anti-caking agent. A redispersible powder, having the polymer particles attached to the surface of the latex particles, is created. This can be redispersed when water is later added, and in drying, the polymer coalesces on a latex film. This process ensures that the polymers redisperses once water is added to the dry mixture.

A suitable example of the polyvinylacetate emulsion is one available from the “National Starch & Chemical Pty Ltd” of Seven Hills, NSW, Australia, under the product designation of “ELOTEX FX2350”. Other similar “ELOTEX” ethylene and vinyl acetate copolymer binders may also be used, including “10166”, “10211”, “1080”, “50E100”, “50E100S”, “50E200”, “50E303”, “50V/920”, “511/44”, “FL1212”, “FL2201”, “FL3200”, “FX320”, “FX3300”, and the like.

Another example, is the EVA powder from the Dairen Chemical Company (Songkiang Road, Taipei Taiwan). These copolymers are provided under the trade names “DA- . . . ” and the “DA-1100” version is particularly suitable. This is a free flowing redispersible powder, which is added to the mixture, in lower quantities than for the ELOTEX version. The DA-1100 EVA may preferably be present in an amount of preferably from 0.01 to 20%, more preferably from 0.05 to 10%, and may be present at an amount of around 0.1% of the initial mixture.

A suitable amount of EVA should be used to create a strong final product. An amount of from 1 kg to 200 kg, (ie 0.1% to 20%) but most preferably from 5 kg to 50 kg (ie, 0.5% to 5%) per 1000 kg by weight of initial mixture is preferred.

Preferably, also the EVA is combined with the dry ingredients, in a “ready-mix” package, to be provided to manufacturers. They then merely need to add water, and form the final building products by casting or extrusion.

### Cement Component

The cement is any type of cement that is used in the industry as a construction material. Preferably the cement is Portland cement. It is also preferred that a high strength Portland cement be used, which is cement with a finer particle size than for standard cement. The cement may include lime.

The cement is added preferably in an amount of at least 15% or preferably 25% to the remaining ingredients to make an aqueous slurry that then dries, and looses some water, to create a building element that has at least 10% of its composition being cement in a hardened form. Preferably less than 70%, and more preferably less than 50% of the initial mixture comprises cement.

### Filler Material Component

The particulate filler material may be any suitable particulate filler material that is used in the industry for the manufacture of concrete, cement products, and the like. Preferably, the filler material may be selected from particulate wood, particulate expanded volcanic silicous rock, particulate elastomeric material, flyash, crushed rock, particulate paper, or other cellulosic materials, or sand, for example, either alone or as mixtures of two or more of these ingredients. It is most preferably chosen from particulate wood, especially sawdust, wood chips or wood shavings. Otherwise, it may be chosen from expanded volcanic silicous rock especially perlite, crushed rock especially powdered limestone, or elastomeric particulate material, especially polystyrene powder. These especially preferred components allow the construction element that is created to be lightweight, in comparison with normal cement and concrete products.

If the filler material is sawdust, then any type of sawdust, wood chips or wood shavings may be used. It may be sourced from hardwood or softwood, and it may be aged or fresh. However it is believed that with the present invention shrinkage is unlikely to occur when fresh, softwood sawdust, chips or shavings is utilised, beyond a short curing period, which means that such sawdust may be utilised if it is available, which is a surprising result. Hardwood is also an ideal ingredient of the composition. Sawdust, chips or shavings confers good acoustic and thermal properties on the final element, and also allows a lightweight element to be created.

When sawdust is utilised in the invention, it may be used as very fine or fine particles. However, coarse sawdust, wood chips or wood shavings may be used, either on its own, or as mixtures of coarse and fine such materials. Ideally, the particulate wood may have average particle sizes in the range of from about 1000 micron up to about 20 to 30 mm. Shavings and wood chips that are waste materials are able to be utilised in the inventions, especially with the use of “DA-1100” EVA.

Wood chips and shavings are less dense than smaller particulate sawdust, and so a lesser weight of the chips or shaving may be used, when compared with finer sawdust. Preferably a greater amount of EVA binder is used with coarser woodchips or shavings when compared with finer sawdust.

As a further alternative, sawdust-type material composed of particles of plants, plant materials, seed materials, and the like may be used, either in place of normal wood sawdust, or in addition to it. Such material can consist of chipped, chopped, or ground leaves, branches, grasses, straw, nuts, nut shells, husks, and the like. It may consist of husks produced as a by-product of the milling of grain seeds, for example rice husks, or nuts. These can be used as is, or ground, chopped, or sieved to give finer particle sizes.

In this specification, the term “sawdust” includes all types of plant materials that are in finely divided form, such as the sawdust, chips or shavings or powder sourced from wood, plant husks, nut shells, and the like.

Other sources of sawdust-type materials may be the use or recycled use of products derived from this same source material, such as paper, cardboard, cotton materials, and the like. Ideally this material is also ground, chopped, or sieved to give various particle sizes. The filler material may be particulate paper, or other cellulosic materials, including cardboard, newsprint, or recycled paper products. These are cellulose containing materials that may also be considered as “sawdust” type materials. Preferably, recycled paper, especially used paper is used, rather than new paper.

The term “particulate wood” used through out this document is to understood to include all suitable types of particulate plant material, of whatever source, such as of trunks, branches, leaves, seed husks, and the like, or of products processed from such source material, such as paper and cardboard. These may be in the form of dust, shavings, or wood chips, of varying sizes, shapes and sources. Mixtures of different such materials may also be utilised. Materials obtained locally may be utilised, such as rice husks in Asian countries. It is often preferred to use at least some actual wood sawdust in the invention, either with other types of particulate wood materials, or together with other filler materials.

Another filler material that may be used is a particulate volcanic silicous rock, especially an expanded type, such as perlite. Expanded perlite is manufactured from crude perlite rock, by crushing the crude rock, then heating it to a temperature above 870 Celcius, at which point the rock particles “pop” due to the presence of small amounts of water in the original volcanic glass rock. The expanded perlite is relatively lightweight for its volume, and is available commercially at densities of from 32 kg/m³ to 240 kg/m³.

The perlite may be used as is, or in a coated form. The perlite is coated with compounds such as silicones, or silanes, or glass, or similar materials, in order to decrease the water absorption of the non-coated product, and to enhance the final product. A coated perlite product may be obtained from the “Harborlite” Company of La Porte Tex., USA, who market a product under the name of “Microfil”, especially grade F-2. Because perlite has a low density, for an equal weight of this filler when compared to other types, then more of the binder is usually required in the mixture, as the quantity of perlite filler is greater.

A particulate rock filler material may also be used. Rock, especially a soft rock which can be crushed more easily, may be prepared as a fine particulate material, and used in the invention, either alone, or with another filler, especially with sawdust. It is preferred to use a crushed limestone, which is prepared as a fine powder with average particle sizes in the range of 500 to 1000 micron.

Another filler material that may be used with the present invention, are elastomeric particulate materials, of the type used in the construction industry to fill and create lightweight concrete. One suitable form of such materials is polystyrene powder or beads.

Other particulate filler materials may be used. These include fly-ash, sand, rock powder, aggregates, and so on. Fly-ash is available as a waste product of power stations and the like, and may be utilised in the present invention, either alone, or in combination with other fillers, and either in it natural state, or after further treatment such as coating it with silicones or silanes, to render it water resistant.

The particulate filler material may be used in its natural form, or treated in a variety of ways, to alter or improve its properties for use in the construction industry. For example the fly-ash, or perlite, may have been coated with agents to alter their water retention properties, such as with silicones or silanes to water-proof the filler material; this process is known in the industry.

In addition, other additives, which are known as colouring agents, or setting agents may be utilised. Other fillers and reinforcing agents, such as fibre-glass or straw may be utilised as well if desired. Other components that alter the appearance of the product, such as to render the finished product with an appearance to resemble natural stone, may also be used with the invention.

Mixtures of two or more of these different fillers, or of different grades, sizes, densities, colours, properties, etc of the fillers, may be used. For example, a mixture of fine and coarser sawdust, chips or shavings may be used. A mixture of sawdust and rice husk powder may be used. A mixture of sawdust and perlite, or sawdust- and polystyrene powder, or sawdust and powdered limestone may be used.

Preferable 15% to 95% of the initial mixture is filler, and more preferably from 20% to 50% is filler.

### Other Components

A cellulose ether is a known binder and thickener product for use in the extrusion of cement products. It may optionally be used in the compositions of the present invention, especially when the product is to be extruded. The cellulose ether component is generally not needed is the products are created by casting with moulds. If used, then up to 8% of the initial mixture may be composed of the cellulose ether, and preferably up to 4%.

If used, the cellulose ethers that are suitable for use in the present invention include sodium carboxymethyl-cellulose, sodium carboxymethyl-hydroxyethyl cellulose, hydroxypropyl-methyl cellulose, hydroxyethyl-methyl cellulose, hydroxyethyl-ethyl cellulose, methyl cellulose, methylethyl cellulose, hydroxyethyl cellulose and hydroxypropyl cellulose. Variations of these substances that have further physical or chemical treatments may also be utilised, such as, for example a partially surface treated hydroxypropyl methyl cellulose.

Preferably the cellulose ether (if used) is a hydroxypropyl-methyl-cellulose, or a hydroxyethyl-methylcellulose compound. A suitable such compound can be obtained from “Filchem Australia Pty Ltd” of Castle Hill NSW Australia, under the product designation “Mecellose”, especially the any of the products, “Mecellose PMB-40HS”, “Mecellose PMB-50US” or “Mecellose EMA-70U”.

As another optional component, a polyvinylactate (PVA) binder may be used, ideally as an emulsion, in addition to the EVA, and it may replace a portion of the EVA in some mixtures. Preferably, a cross-linked PVA may be used. This component may be utilised especially with extrusion.

The polyvinylactate (PVA) emulsion component is ideally added in the form of an emulsion in water. While any suitable polyvinylacetate emulsion may be utilised in the invention, it has been found that a high molecular weight and cross-linking PVA emulsion gives effective results. But normal PVA may be used instead, or in addition.

In any PVA emulsion, the solids component is primarily polyvinylacetate, which may often contain a small amount of polyvinylalcohol, as a stabilizer. It is preferred that the polyvinylacetate emulsion is a cross-linking PVA. The emulsion may also contain one of more cross-linking monomers, and in this situation, may preferably also contain a catalyst or cross-linking promoter. The cross-linking monomers and catalysts are known in the industry for this purpose; for example a common catalyst is aluminium chloride. It is also preferred that the polyvinylacetate is a high molecular weight polymer, ideally with an average polymer molecular weight of 500,000 or more.

A suitable example of the polyvinylacetate emulsion is one available from the “National Starch & Chemical Pty Ltd” of Seven Hills, NSW, Australia, under the product designation of “Kor-Lok 442.3051”. This product is a cross-linking polyvinylacetate emulsion in water. It contains the following components:—about 43% (by weight compared to total weight of emulsion) of polyvinylacetate, about 3.5% polyvinylalcohol stabilizer, cross-linking monomer(s) 0.2%, catalyst 2.2%, and the remainder comprising water. It is a white fluid, pH of 3.3-3.7, with a high molecular weight (>500,000) which is commonly used as an adhesive.

The preferred PVA has a high molecular weight as determined by the “air dried insolubles” test, which is a known test in the industry for determining the molecular weight of polymer emulsions, where its insolubles are determined to have a value of greater than 70%.

Another PVA emulsion that may be used with the invention is “Bondcrete”™ PVA bonding agent, available from the “Bondall Building & Renovating Products” company of Belmont, Western Australia. It is believed to be a PVA Copolymer Emulsion in water, containing 30-60% of poly (vinyl acetate) modified, less than 5% of poly (vinyl alcohol) modified, less than 5% dipropylene glycol dibenzoate, less than 1% or formic acid, less than 0.1% glyoxal, and the remainder being water. It appears as a milky white liquid with an odour.

When the PVA component is utilised, then a proportional amount to the amount of EVA, is preferred, perhaps as much as double the amount, or at least an equal amount of EVA may be used, as a preferred option in the admixture. Preferably from 0.1 up to 40% of the initial mixture may be PVA, most preferably from 0.5 up to 20% or up to 10%.

### Construction Element and Process

The final product may be prepared by any suitable process, but is preferably made is by an extrusion process, or by casting. A slurry with water is prepared, or allowed to commence the setting process, until it forms a texture and consistency that it can be passed into an extrusion machine, or cast into a mould. The product is then allowed to set and cure.

When the slurry is prepared, water is added, preferably to the mixture of all the dry components. When the element is allowed to dry, set and cure, then about 70% of the water that is present in the original slurry is lost, through evaporation. About 30% of the water present remains behind, bound up in the solids matrix. The exact amount of water that remains depends on the humidity of the surroundings.

Preferably the slurry mixture is prepared that may include, (a) 25% to 70% by weight of cement, (b) 15% to 95% by weight of particulate filler material, (c) 0.1% to 20% by weight of ethylene and vinyl acetate copolymer binder, (d) 0% to 8% by weight of cellulose ether, or 0% to 40% of PVA binder, and (e) 15% to 50% by weight water, wherein the percentages by weight are selected to total 100%. More preferably the mixture may include, (a) 25% to 50% by weight of cement, (b) 20% to 50% by weight of particulate filler material, (c) 0.5% to 5% by weight of ethylene and vinyl acetate copolymer binder, (d) 0% to 4% by weight of cellulose ether or (e) 0% to 10% of PVA binder, and (f) 15% to 50% by weight water. If other components are present, the proportions are adjusted accordingly, so that the total amount is 100%.

The slurry may be prepared by any suitable means. One method may comprise preparing a slurry mixture containing; (a) at least 15% by weight of cement, (b) particulate filler material, (c) ethylene and vinyl acetate copolymer binder, optionally (d) cellulose ether, or (e) PVA, and (f) water, by the steps of:—(i) mixing the dry components (a) and (b) and (c) and optionally (d) together, (ii) mixing these components with water and optionally (e), to form a slurry and continuing the mixing until all the constituents are evenly distributed, (iii) forming the resulting slurry into a shape suitable for the construction element, and (iv) allowing it to set and harden.

When the material sets it contains less water. The resulting dried and aged construction element contains at least 10% (or more) by weight of cement component. It therefore may preferably contain equivalents amounts of (a) cement, (b) 1 particulate filler material, (c) ethylene and vinyl acetate copolymer binder, or if used, (d) cellulose ether, or (e) PVA binder, and (f) the remainder including water trapped within the element. More preferably the element after setting may comprise (a) 15% to 50% by weight of cement, (b) 15% to 50% by weight of particulate filler material, (c) 0.2% to 15% by weight of ethylene and vinyl acetate copolymer binder, and or if used (d) 0 to 4%, by weight of cellulose ether, or (e) if used then 0% to 10% of PVA emulsion binder, wherein the percentages by weight are selected to total 100%. If other components are present, the proportions are adjusted accordingly.

The extruded product may be in a variety of shapes, and any desired cross-sectional sizes. The product may be produced especially as a thin board, with a thickness preferably of between 20 mm to 40 mm. The board may have a width ideally in the range of 600 mm to 900 mm, depending on the machinery used to manufacture it. The boards can be manufactured in long lengths such as 7 to 8 metres, by extrusion, and then cut to suitable lengths as they are extruded from the machine, or left in longer lengths, and divided later into smaller sizes.

As an alternative, the product may be made by casting it, using standard casting techniques in the building industry. Casting has some advantages over extrusion. It is more economical, it requires less expensive, and simpler equipment, and can be used to create products with complex shapes. The mixture for casting also does not require the inclusion of a cellulose ether which provides a cost saving.

The casting process requires the creation and preparation of a mould, which is common in the building industry. The slurry mixture in accordance with the invention, is prepared, and is continuously stirred and mixed in order to prevent it setting. It is introduced into the mould, preferably by pumping it, under some pressure, to remove or minimise air pockets and bubbles. The mould may be coated with a release agent, or else this may be omitted, in accordance with normal techniques. Generally, the products made in accord with the present invention form a good quality surface. The product may be allowed to dry for an appropriate period, commonly from 2 to 6 hours, before being removed from the mould and allowed for fully dry and cure.

The element may also be produced as a panel. The panel may have a width ideally in the range of 600 mm, with a thickness generally in the range of from 40 to 190 mm. The panels can be produced in any suitable length, such as in the range of from 2.4 to 3.6 metres long, as they are extruded from the machine. They may be manufactured as longer lengths that can be divided later into smaller sizes. The panels may also be extrudes so as to contain longitudinal air voids, so as to further reduce their weight. A series of circular or oval or rectangular voids may run the length of the panel. The top and bottom edges of the panel may be shaped to form a tongue and groove arrangement, so that the panels can interlock with each other. The ends may also be shaped in this manner.

The elements are strong, with a tensile strength of from 8 to 20 MPa, and according to the components chosen, in the order of from 13 to 15 MPa.

The building elements may have surface treatments, to improve their appearance, such as attractive patterns or colours. The elements may have surface protection layers or coatings incorporated in them. The surfaces of panels may be patterned to resemble an area of brickwork, for example. Ribs, grooves and similar surface decoration, or strengthening elements may be included in the elements, especially when they are produced as panel elements. Internal, or surface, wiring or ducting may be included in the building element, during their manufacture or later, as a separate step.

For instance, a colouring pigment may be added to the slurry mixture, to provide coloured elements. A marble of granite composite may be added as a surface layer around 3 mm thick. Aluminium or steel sheet cladding may be glued to the exterior of the elements. A box type structure may be manufactured from the elements of the invention combined with steel or aluminium sheets for example. A surface layer of paper or board may be glued or otherwise affixed to the surface of the elements.

In addition, the product may be created as a sandwich product, with the slurry introduced between two panels of other materials, such as aluminium, steel, timber veneer, plastic veneer, paper or cardboard, for instance. Alternatively, the surface layer may be added later, either during the production process, or after to a sheet of the cement product of the invention, such as adding a surface paper layer to the cement sheet.

The following table provide some indicative amounts of the various components, for use in both extrusion and casting approaches to producing building elements. Not all the listed components need be used together; the indicative amounts are a typical quantity for when each component is used.

| | Extrusion | | Casting |
|---|---|---|---|
| | Amount | Casting | Amount |
| | (kg) | Components | (kg) |
| Cement | 300 | Cement | 300 |
| Sawdust | 400 | Sawdust | 300-400 |
| Woodchips | 200-400 | Woodchips | 200-400 |
| Perlite or coated perlite | 150 | Perlite or coated perlite | 100 |
| Ethylene and vinyl | 10-50 | Ethylene and vinyl | 10-50 |
| acetate copolymer | | acetate copolymer | |
| Hydroxypropyl methyl | 10-20 | Polystyrene granules or | 25-30 |
| cellulose | | powder | |
| Limestone (powdered) | 150-200 | Fly ash | 150 |
| Polystyrene granules or | 25-30 | | |
| powder | | | |
| Cross-linked PVA | 40-60 | | |
| Rice husk | 150 | | |
| PVA | 100 | | |
| Particulate paper | 150-200 | | |
| Fly ash | 300 | | |
| Water | 300-400 | | |

### EXAMPLES

In these examples the ethylene and vinyl acetate (EVA) binder indicated as “*” is the “DA-1100” EVA.

### Example 1

A concrete-type product was prepared by extrusion as follows:—

| | | Approx % |
|---|---|---|
| Components | Weight (kg) | (by weight) |
| Cement | 300 | 28% |
| Sawdust | 300 | 28% |
| Perlite or coated perlite | 100 | 10% |
| Ethylene and vinyl acetate binder* | 10 | 1% |
| Hydroxypropyl methyl cellulose | 10 | 1% |
| Water | 250 | 24% |
| (Total) | (970) | 100% |

### Example 1A

The concrete-type mixture was prepared with the same components as in Example 1, but with the EVA binder present in an amount of 25 kg.

### Example 2

A concrete-type product was prepared by extrusion as follows:—

| | | Approx % |
|---|---|---|
| Components | Weight (kg) | (by weight) |
| Cement | 300 | 32% |
| Perlite or coated perlite | 300 | 32% |
| Ethylene and vinyl acetate binder* | 15 | 1% |
| Hydroxypropyl methyl cellulose | 10 | 1% |
| Water | 300 | 32% |
| (Total) | (925) | 100% |

### Example 2A

The concrete-type mixture was prepared with the same components as in Example 2, but with the EVA binder present in an amount of 30 kg, and hydroxyl methyl cellulose present as 20 kg.

### Example 3

A concrete-type product was prepared by extrusion as follows:—

| | | Approx % |
|---|---|---|
| Components | Weight (kg) | (by weight) |
| Cement | 300 | 28% |
| Sawdust | 400 | 40% |
| Ethylene and vinyl acetate binder* | 25 | 2% |
| Hydroxypropyl methyl cellulose | 10 | 1% |
| Water | 300 | 28% |
| (Total) | (1035) | 100% |

### Example 3A

The concrete-type mixture was prepared with the same components as in Example 3, but with sawdust present in an amount of 500 kg, and ethylene and vinyl acetate binder present in an amount of 50 kg.

### Example 4

A concrete-type product was prepared by extrusion as follows:—

| | | Approx % |
|---|---|---|
| Components | Weight (kg) | (by weight) |
| Cement | 300 | 32% |
| Sawdust | 150 | 16% |
| Rice husk | 150 | 16% |
| Ethylene and vinyl acetate binder* | 15 | 1% |
| Hydroxypropyl methyl cellulose | 10 | 1% |
| Water | 300 | 32% |
| (Total) | (925) | 100% |

### Example 4A

A concrete-type product was prepared by extrusion as follows:—

| | | Approx % |
|---|---|---|
| Components | Weight (kg) | (by weight) |
| Cement | 300 | 32% |
| Sawdust | 150 | 16% |
| Particulate paper | 150 | 16% |
| Ethylene and vinyl acetate binder* | 25 | 2% |
| Hydroxypropyl methyl cellulose | 20 | 2% |
| Water | 300 | 32% |
| (Total) | (945) | 100% |

In this example, recycled paper, which has been finely divided was utilised to make the mixture. It was repeated with the EVA present as 50 kg.

### Example 4B

A concrete-type product was prepared by casting as follows:—

| | | Approx % |
|---|---|---|
| Components | Weight (kg) | (by weight) |
| Cement | 300 | 35% |
| Woodchips and wood shavings | 200 | 18% |
| Ethylene and vinyl acetate binder* | 60 | 8% |
| Hydroxypropyl methyl cellulose | 10 | 1% |
| Water | 300 | 32% |
| (Total) | (870) | 100% |

### Example 5

A concrete-type product was prepared by extrusion as follows:—

| | | Approx % |
|---|---|---|
| Components | Weight (kg) | (by weight) |
| Cement | 300 | 35% |
| Sawdust | 200 | 24% |
| Polystyrene Powder | 25 | 2% |
| Ethylene and vinyl acetate binder* | 25 | 2% |
| Hydroxypropyl methyl cellulose | 20 | 2% |
| Water | 300 | 35% |
| (Total) | (870) | 100% |

### Example 5A

A concrete-type product was prepared by casting as follows:—

| | | Approx % |
|---|---|---|
| Components | Weight (kg) | (by weight) |
| Cement | 300 | 35% |
| Wood chips and shavings | 100 | 24% |
| Polystyrene Powder | 25 | 2% |
| Ethylene and vinyl acetate binder* | 40 | 2% |
| Hydroxypropyl methyl cellulose | 20 | 2% |
| Water | 300 | 35% |
| (Total) | (785) | 100% |

### Example 6

A concrete-type product was prepared by extrusion as follows:—

| | | Approx % |
|---|---|---|
| Components | Weight (kg) | (by weight) |
| Cement | 300 | 32% |
| Sawdust | 150 | 15% |
| Limestone (powdered) | 150 | 15% |
| Ethylene and vinyl acetate binder* | 15 | 3% |
| Hydroxypropyl methyl cellulose | 20 | 3% |
| Water | 300 | 32% |
| (Total) | (935) | 100% |

The mixtures in Examples 1 to 6 were processed through an extrusion machine that is commonly used in the industry, and formed into panels and board construction elements. The building elements were allowed to set and cure. Testing of the elements indicated that they were exceptionally hard, and strong. It was very difficult to mark the surface of the elements, and they were very light in comparison with normal concrete elements of the same size and shape.

### Example 7

A concrete-type product was prepared by casting as follows:—

| | | Approx % |
|---|---|---|
| Components | Weight (kg) | (by weight) |
| Cement | 300 | 30% |
| Sawdust | 300 | 30% |
| Perlite or coated perlite | 100 | 10% |
| Ethylene and vinyl acetate binder* | 50 | 5% |
| Water | 250 | 25% |
| (Total) | (1000) | 100% |

This example was repeated with 350 kg of water.

### Example 8

A concrete-type product was prepared by casting as follows:—

| | | Approx % |
|---|---|---|
| Components | Weight (kg) | (by weight) |
| Cement | 300 | 32% |
| Perlite or coated prelite | 300 | 32% |
| Ethylene and vinyl acetate binder* | 30 | 4% |
| Water | 300 | 32% |
| (Total) | (930) | 100% |

### Example 8A

A concrete-type product was prepared with similar components to that given in Example 8, but with the EVA binder present in an amount of 50 kg.

### Example 9

A concrete-type product was prepared by extrusion as follows:—

| | | Approx % |
|---|---|---|
| Components | Weight (kg) | (by weight) |
| Cement | 300 | 28% |
| Sawdust | 400 | 38% |
| Ethylene and vinyl acetate binder* | 25 | 2% |
| Cross-linked PVA | 40 | 4% |
| Water | 300 | 28% |
| (Total) | (1065) | 100% |

### Example 10

A concrete-type product was prepared by extrusion as follows:—

| | | Approx % |
|---|---|---|
| Components | Weight (kg) | (by weight) |
| Cement | 300 | 32% |
| Sawdust | 150 | 16% |
| Rice husk | 150 | 16% |
| Ethylene and vinyl acetate binder* | 25 | 3% |
| Water | 300 | 32% |
| (Total) | (925) | 100% |

### Example 11

A concrete-type product was prepared by casting as follows:—

| | | Approx % |
|---|---|---|
| Components | Weight (kg) | (by weight) |
| Cement | 300 | 35% |
| Sawdust | 200 | 24% |
| Polystyrene Powder | 25 | 3% |
| Ethylene and vinyl acetate binder* | 25 | 3% |
| Water | 300 | 35% |
| (Total) | (850) | 100% |

### Example 12

A concrete-type product was prepared by casting as follows:—

| | | Approx % |
|---|---|---|
| Components | Weight (kg) | (by weight) |
| Cement | 300 | 32% |
| Sawdust | 150 | 16% |
| Limestone (powdered) | 150 | 16% |
| Ethylene and vinyl acetate binder* | 25 | 3% |
| Water | 300 | 32% |
| (Total) | (925) | 100% |

The mixtures in Examples 7 to 12 were processed either through an extrusion machine that is commonly used in the industry, and formed into panels and board construction elements, or by casting. When cast, the mixture was put into moulds, by pumping under pressure, all the while continuously mixing and stirring the slurry, until the mould was filled. The elements were removed from the mould, after 2 to 6 hours, when set, and allowed to cure. They were allowed to set and cure. Testing of the elements indicated that they were exceptionally hard, and strong, and very light in comparison with normal concrete elements of the same size and shape.

### Example 13

A concrete-type product was prepared by casting as follows:—

| | | Approx % |
|---|---|---|
| Components | Weight (kg) | (by weight) |
| Cement | 300 | 29% |
| Sawdust | 300 | 29% |
| Perlite or coated perlite | 150 | 14% |
| Ethylene and vinyl acetate binder* | 40 | 4% |
| Water | 250 | 24% |
| (Total) | (1040) | 100% |

### Example 14

A concrete-type product was prepared by casting as follows:—

| | | Approx % |
|---|---|---|
| Components | Weight (kg) | (by weight) |
| Cement | 300 | 29% |
| Perlite or coated perlite | 300 | 29% |
| Ethylene and vinyl acetate binder* | 40 | 4% |
| Water | 400 | 38% |
| (Total) | (1040) | 100% |

### Example 15

A concrete-type product was prepared by casting as follows:—

| | | Approx % |
|---|---|---|
| Components | Weight (kg) | (by weight) |
| Cement | 300 | 28% |
| Sawdust | 400 | 38% |
| Ethylene and vinyl acetate binder* | 25 | 2% |
| Water | 300 | 28% |
| (Total) | (1025) | 100% |

### Example 16

A concrete-type product was prepared by extrusion as follows:—

| | | Approx % |
|---|---|---|
| Components | Weight (kg) | (by weight) |
| Cement | 300 | 27% |
| Sawdust | 150 | 14% |
| Rice husk | 150 | 14% |
| Ethylene and vinyl acetate binder* | 30 | 3% |
| Cross-linked PVA | 40 | 3% |
| Hydroxyethyl-methyl-cellulose | 20 | 2% |
| Water | 400 | 37% |
| (Total) | (1090) | 100% |

### Example 17

A concrete-type product was prepared by extrusion as follows:—

| | | Approx % |
|---|---|---|
| Components | Weight (kg) | (by weight) |
| Cement | 300 | 32% |
| Sawdust | 200 | 21% |
| Polystyrene Powder | 25 | 3% |
| Ethylene and vinyl acetate binder* | 25 | 3% |
| Cross-linked PVA | 50 | 5% |
| Hydroxyethyl-methyl-cellulose | 20 | 2% |
| Water | 300 | 32% |
| (Total) | (920) | 100% |

### Example 18

A concrete-type product was prepared by extrusion as follows:—

| | | Approx % |
|---|---|---|
| Components | Weight (kg) | (by weight) |
| Cement | 300 | 32% |
| Sawdust | 150 | 16% |
| Limestone (powdered) | 150 | 16% |
| Ethylene and vinyl acetate binder* | 25 | 2% |
| Hydroxyethyl-methyl-cellulose | 20 | 2% |
| Water | 300 | 32% |
| (Total) | (945) | 100% |

### Example 19

A concrete-type product was prepared by extrusion as follows:—

| | | Approx % |
|---|---|---|
| Components | Weight (kg) | (by weight) |
| Cement | 300 | 31% |
| Fly ash | 300 | 31% |
| Ethylene and vinyl acetate binder | 40 | 4% |
| Hydroxypropyl methyl cellulose | 20 | 3% |
| Water | 300 | 31% |
| (Total) | (960) | 100% |

### Example 20

A concrete-type product was prepared by casting as follows:—

| | | Approx % |
|---|---|---|
| Components | Weight (kg) | (by weight) |
| Cement | 300 | 32% |
| Fly ash | 300 | 32% |
| Ethylene and vinyl acetate binder | 50 | 4% |
| Water | 300 | 32% |
| (Total) | (950) | 100% |

Some of the mixtures in Examples 13 to 20 were processed through an extrusion machine that is commonly used in the industry, and formed into panels and board construction elements. They were allowed to set and cure. Some of the Examples were also tested by casting in moulds. The elements were exceptionally hard, and strong, with the panels having a high tensile strength, and they were very light in comparison with normal concrete elements of the same size and shape.

Throughout this specification, unless the text indicates otherwise, the word “comprise”, and variations such as “comprises” or “comprising”, are to be understood to imply the inclusion of a stated integer or step or group of integers or steps, but not the exclusion of any other integer or step or group of integers or steps.

### INDUSTRIAL APPLICABILITY

The building elements are used in the construction industry, especially where lightweight and strong panels and boards are required.

The products made according to the invention are very strong, they can be cast or extruded with almost immediate setting, and they exhibit minimal shrinkage. After a short time, like a few weeks, they can be used in the building industry. The products exhibit high water-resistance, and good thermo-insulation properties. It is possible to make a lighter weighing product, which is very useful in the building industry.

Normal precast concrete does not have good thermal insulation properties. New regulations by the Australian Building Codes Board in the Building Codes of Australia relating to external walls for factories, houses and apartments now require them to have better thermal insulation. With existing precast concrete walls, it has now become expensive to meet this new criteria. However, super lightweight concrete panels and building elements according to the present invention, based on cement and sawdust, woodchips or shavings have high thermal insulation values, as well as excellent fire resistance and noise resistance. Furthermore, the building products made according to the present invention can be easily worked using drilling, nailing, and cutting, which provides significant cost savings in the building and construction industry.

The presence of the EVA binder creates a thicker and more workable mixture, which is optimum for extrusion and casting. There is also minimal shrinkage of the final product after curing the EVA binder creates a good bond between the various components, which creates a very strong product.

It will be apparent that obvious variations or modifications may be made in accordance with the spirit of the invention that are intended to be part of the invention, and any such obvious variations or modification are therefore within the scope of the invention.

1. A construction element that includes,
(a) at least 10% by weight of cement,
(b) particulate filler material, and
(c) ethylene and vinyl acetate copolymer binder,
which has been mixed together in the presence of water, formed into a shape suitable as a construction element, and allowed to set and harden.

2. The construction element of Exclaim 1, that also includes
(d) cellulose ether.

3. The construction element of Exclaim 1, that also includes
(e) PVA emulsion binder.

4. The construction element of claim 3, wherein said PVA emulsion is a cross-linked high molecular weight PVA emulsion.

5. The construction element of claim 1, wherein said ethylene and vinyl acetate copolymer binder is a dry powder.

6. The construction element of claim 1, wherein said ethylene and vinyl acetate copolymer binder is “DA-1100” polymer binder (as herein defined).

7. The construction element of claim 1, that includes,
(a) 20% to 70% by weight of cement,
(b) 10% to 95% by weight of particulate filler material,
(c) 0.1% to 20% by weight of ethylene and vinyl acetate copolymer binder,
(d) 0% to 8% by weight of cellulose ether,
(e) 0% to 40% of PVA binder, and
the remainder including water trapped within said element
wherein the percentages by weight are selected to total 100%.

8. The construction element of claim 7, that includes,
(a) 20% to 50% by weight of cement,
(b) 15% to 50% by weight of particulate filler material,
(c) 0.5% to 15% by weight of ethylene and vinyl acetate copolymer binder, and
(d) 0% to 4% by weight of cellulose ether,
(e) 0% to 10% of PVA binder, and
the remainder including water trapped within said element
wherein the percentages by weight are selected to total 100%.

9. The construction element of claim 1, wherein said filler material is selected from one or more of: particulate wood, particulate expanded volcanic silicous rock, elastomeric particulate material, flyash, particulate rock, particulate paper, or sand.

10. The construction element of claim 9, wherein said filler material is chosen from among, particulate wood that is sawdust, wood chips, or wood shavings, particulate expanded volcanic silicous rock that is perlite, elastomeric particulate material that is polystyrene powder, or particulate rock that is powdered limestone, or from particulate recycled paper.

11. The construction element of claim 9, wherein at least a major part of said filler material is particulate wood that is sawdust, wood chips, or wood shavings.

12. The construction element of claim 10, wherein said filler material is finely divided, with an average particle sizes of less than 1000 micron.

13. The construction element of claim 10, wherein said filler material has an average particle sizes of less than 20 mm.

14. The construction element of claim 1, wherein said cement is Portland cement.

15. The construction element of claim 2, wherein said cellulose ether is hydroxypropylmethyl cellulose.

16. The construction element of claim 1, which includes one or more additional ingredients, selected from fillers, colouring agents, and setting agents.

17. The construction element of claim 1, which is in the shape of a panel, board, block or beam.

18. A slurry mixture for producing a construction element that includes,
(a) at least 15% by weight of cement,
(b) particulate filler material,
(c) ethylene and vinyl acetate copolymer binder, and
water, sufficient to make a settable slurry.

19. The mixture of claim 18 which also includes
(d) cellulose ether.

20. The mixture of claim 18 which also includes
(e) PVA emulsion binder.

21. The mixture of claim 20, wherein said binder is a cross-linked high molecular weight PVA binder.

22. The mixture of claim 18, wherein said ethylene and vinyl acetate copolymer binder is initially a dry powder.

23. The mixture of claim 18, wherein said ethylene and vinyl acetate copolymer binder is “DA-1100” polymer binder (as herein defined).

24. The mixture of claim 18, that includes,
(a) 25% to 70% by weight of cement,
(b) 15% to 95% by weight of particulate filler material,
(c) 0.1% to 20% by weight of ethylene and vinyl acetate copolymer binder,
(d) 0% to 8% by weight of cellulose ether,
(e) 0% to 40% of PVA emulsion binder, and
(f) 15% to 50% by weight water,
wherein the percentages by weight are selected to total 100%.

25. The mixture of claim 18, that includes,
(a) 25% to 50% by weight of cement,
(b) 20% to 50% by weight of particulate filler material,
(c) 0.5% to 5% by weight of ethylene and vinyl acetate copolymer binder,
(d) 0% to 4% by weight of cellulose ether,
(e) 0% to 10% of PVA emulsion binder, and
(f) 15% to 50% by weight water.

26. The mixture of claim 18, wherein said filler material is selected from one or more of: particulate wood, particulate expanded volcanic silicous rock, elastomeric particulate material, flyash, particulate paper, or sand.

27. The mixture of claim 26, wherein said filler material is chosen from among; particulate wood that is sawdust wood ships or wood shavings, particulate expanded volcanic silicous rock that is perlite, elastomeric particulate material that is polystyrene powder, particulate rock that is powdered limestone, or particulate recycled paper.

28. The mixture of claim 26, wherein at least a major part of said filler material is particulate wood that is sawdust, wood chips, or wood shavings.

29. The mixture of claim 27, said particulate filler material is finely divided, with average particle sizes of up to 1000 micron.

30. The mixture of claim 27, wherein said filler material has an average particle sizes of less than 20 mm.

31. The mixture of claim 18, wherein said cement is Portland cement.

32. The mixture of claim 19, wherein said cellulose ether is hydroxypropylmethyl cellulose.

33. The mixture of claim 18, which includes one or more additional ingredients, selected from fillers, colouring agents, and setting agents.

34. A process for producing a construction element, comprising preparing a slurry mixture containing:
(a) at least 15% by weight of cement, (b) particulate filler material, (c) ethylene and vinyl acetate copolymer binder, (d) optionally cellulose ether, and water sufficient to produce a settable slurry, by the steps of:—
(i) mixing the components (a) and (b) and (c) and optionally (d) together,
(ii) mixing together (i) and water to form a slurry and continuing the mixing until all the constituents are evenly distributed,
(iii) forming the resulting slurry into a shape suitable for the construction element, and
(iv) allowing it to set and harden.

35. The process of claim 34, wherein in step (iii) said forming is conducted by extrusion.

36. The process of claim 34, wherein in step (iii) said forming is conducted by casting.

37. The process of claim 36, wherein said mixing in step (ii) continues until said slurry is introduced into a casting mould.

38. The process of claim 34, wherein said ethylene and vinyl acetate copolymer binder is initially a dry powder.

39. The process of claim 34, wherein said ethylene and vinyl acetate copolymer binder is “DA-1100” polymer binder (as herein defined).

40. The process of claim 34, that includes,
(a) 25% to 70% by weight of cement,
(b) 15% to 95% by weight of particulate filler material,
(c) 0.1% to 20% by weight of ethylene and vinyl acetate copolymer binder,
(d) 0% to 8% by weight of cellulose ether,
(e) 0% to 40% of PVA binder, and
(f) 15% to 50% by weight water,
wherein the percentages by weight are selected to total 100%.

41. The process of claim 40, that includes,
(a) 25% to 50% by weight of cement,
(b) 20% to 50% by weight of particulate filler material,
(c) 0.5% to 5% by weight of ethylene and vinyl acetate copolymer binder,
(d) 0% to 4% by weight of cellulose ether, and
(e) 0% to 10% of PVA binder, and
(f) 15% to 50% by weight water
wherein the percentages by weight are selected to total 100%.

42. The process of claim 34, wherein said filler material is selected from one or more of: particulate wood, particulate expanded volcanic silicous rock, particulate elastomeric material, flyash, particulate stone, particulate paper, or sand.

43. The process of claim 42, wherein said filler material is selected from among particulate wood that is sawdust wood chips or wood shavings, particulate expanded volcanic silicous rock that is perlite, elastomeric material that is polystyrene powder, or particulate rock that is limestone powder, or particulate recycled paper.

44. The process of claim 42, wherein at least a major part of said filler material is particulate wood that is sawdust, wood chips, or wood shavings.

45. The process of claim 44, wherein said filler material is finely divided, with an average particle sizes of less than 1000 micron.

46. The process of claim 44, wherein said filler material has an average particle sizes of less than 20 mm.

47. The process of claim 34, wherein said cement is Portland cement.

48. The process of claim 34, wherein said cellulose ether, if present, is hydroxypropylmethyl cellulose, and said process utilises extrusion.

49. The process of claim 34, which includes one or more additional ingredients, selected from fillers, colouring agents, and setting agents.
